(19) United States
(12) Patent Application Publication
(10) Pub. No.: US 2018/0239196 A1
(43) Pub. Date: Aug. 23, 2018

(54) COLOR FILM, SUBSTRATE AND DISPLAY DEVICE

(71) Applicant: BOE TECHNOLOGY GROUP CO., LTD., Beijing (CN)

(72) Inventors: Tingting Zhou, Beijing (CN); Bin Zhang, Beijing (CN); Xiaolong He, Beijing (CN); Yonglian Qi, Beijing (CN); Jiushi Wang, Beijing (CN)

(21) Appl. No.: 15/572,458

(22) PCT Filed: Apr. 27, 2017
(86) PCT No.: PCT/CN2017/082148

§ 371 Date: Nov. 7, 2017

(30) Foreign Application Priority Data
May 6, 2016 (CN) 201610299368.1

(51) Int. Cl. G02F 1/1335; G02F 1/1337; B32B 27/20; G02B 5/22; G02F 1/017

(52) U.S. Cl. CPC G02F 1/133609; G02F 1/133514; G02F 1/1337; C09K 19/60; G02B 5/223; G02F 1/017; G02F 2001/01791; B32B 27/20

(57) ABSTRACT

Provided are a color film, a substrate and a display device. The color film is used for transmitting a light with one color of three primary colors, and comprises a first absorbing pigment and a second absorbing pigment, wherein absorption spectrum ranges of the first and second absorbing pigments correspond to spectral bands of lights with the other two colors of the three primary colors respectively.

### CROSS REFERENCE

The present disclosure claims a priority benefit of Chinese Patent Application No. 201610299368.1, filed on May 6, 2016, and the entire contents thereof are incorporated herein by reference.

### TECHNICAL FIELD

The present disclosure relates to the technical field of display, and particularly to a color film, a substrate and a display device.

### BACKGROUND ART

In a liquid crystal display device, a backlight source is needed to provide a light source to the display device, since the liquid crystal molecules per se do not emit light. The quantum dot in a quantum dot backlight source can emit fluorescence under photo excitation, and has characteristics such as narrow half peak width of its emission spectrum, high hue, high quantum yield, and the emission spectrum variable in the visible light region and the near infrared region by adjusting the size of the quantum dot. Therefore, recently, the quantum dot backlight source has been widely used in the liquid crystal display device. However, when the light emitted by the quantum dot backlight source passes through a conventional color film, a problem of reduced color purity may occur.

### SUMMARY

The present disclosure provides a color film, a substrate and a display device.

A first aspect of the present disclosure provides a color film for transmitting a light with one color of three primary colors, wherein the color film comprises a first absorbing pigment and a second absorbing pigment, and absorption spectrum ranges of the first absorbing pigment and the second absorbing pigment correspond to spectral bands of lights with the other two colors of the three primary colors respectively.

In some embodiments, the three primary colors are red, green and blue.

In some embodiments, the light comprising the three primary colors is emitted by a quantum dot white light source.

In some embodiments, the first absorbing pigment and/or the second absorbing pigment are/is an organic pigment.

In some embodiments, the absorption spectrum range of the first absorbing pigment corresponds to the spectral band of red light, and the first absorbing pigment has a molecular structural formula of:

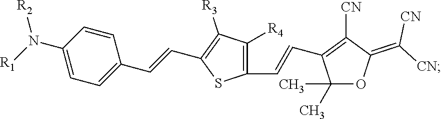

wherein, R₁ and R₂ each are independently selected from one of —H, —(CH₂)ₙ—CH₃ (n=0-10), —CH₂(CH₂)ₙOH (n=0-10),

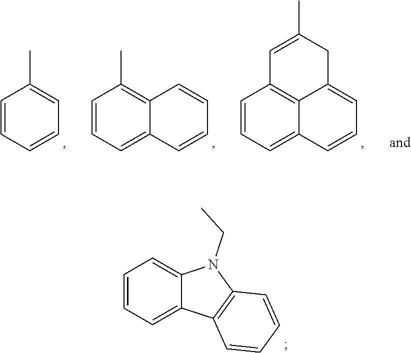

and R₃ and R₄ each are independently selected from one of —H, —(CH₂)ₙ—CH₃ (n=0-11), —O—(CH₂)ₙ—CH₃ (n=0-11), —O—Si(CH₃)₂—Si(CH₃)₃, —O—Si(CH₃)₃, and

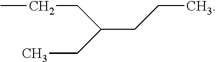

In some embodiments, the absorption spectrum range of the first absorbing pigment corresponds to the spectral band of blue light, and the first absorbing pigment has a molecular structural formula of:

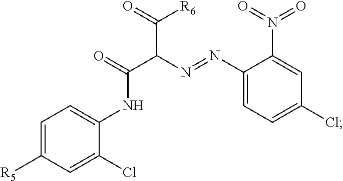

wherein, R₅ and R₆ each are independently selected from one of —H, —(CH₂)ₙ—CH₃ (n=0-10), —CH₂(CH₂)ₙOH (n=0-10),

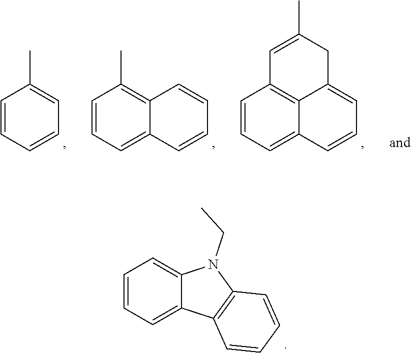

In some embodiments, the absorption spectrum range of the first absorbing pigment corresponds to the spectral band of green light, and the first absorbing pigment has a molecular structural formula of:

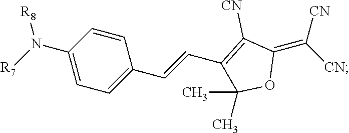

wherein, R₇ and R₈ each are independently selected from one of —H, —(CH₂)ₙ—CH₃ (n=0-10), —CH₂(CH₂)ₙOH (n=0-10),

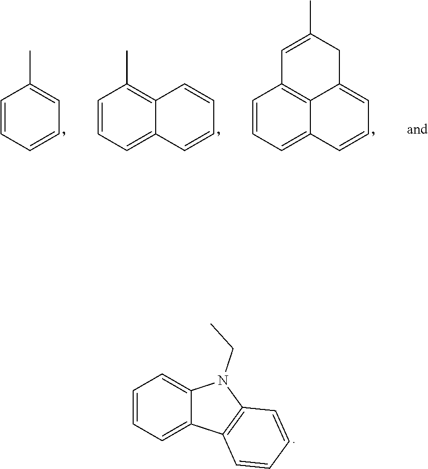

In some embodiments, the sum of the mass percent contents of the first absorbing pigment and the second absorbing pigment in the color film is 5%˜40%.

In some embodiments, the color film further comprises a resin, an unsaturated double bond-containing monomer, a photo-initiator, a silicone coupling agent, an auxiliary agent and a solvent.

In some embodiments, the color film may comprise a first sub-color film and a second sub-color film disposed as a stack; wherein the first sub-color film comprises the first absorbing pigment, and the second sub-color film comprises the second absorbing pigment.

In some embodiments, when the color film comprises a first sub-color film and a second sub-color film disposed as a stack, the mass percent content of the first absorbing pigment in the first sub-color film is 5%˜40%, and the mass percent content of the second absorbing pigment in the second sub-color film is 5%˜40%.

A second aspect of the present disclosure provides a substrate comprising the color film described above.

A third aspect of the present disclosure provides a display device comprising a backlight source, an array substrate, a cell aligning substrate, and a liquid crystal layer positioned between the array substrate and the cell aligning substrate; wherein the array substrate or the cell aligning substrate comprises the color film described above.

In some embodiments, the backlight source is a quantum dot white backlight source.

In some embodiments, the color film contained in the array substrate or in the cell aligning substrate includes three kinds of color films each of which transmits a light with one color of the three primary colors.

In some embodiments, the color film contained in the array substrate or in the cell aligning substrate includes a red color film, a green color film and a blue color film.

### BRIEF DESCRIPTION OF DRAWINGS

To more clearly illustrate the technical solutions in the examples of the present disclosure or in prior art, the drawings to be used in the description of the examples or prior art will be briefly introduced below. Obviously, the following descriptions of the drawings are only some examples of the present disclosure, and other drawings can be obtained by those skilled in the art according to these drawings without inventive efforts.

FIG. 1(a) shows an emission spectrum of a quantum dot backlight source and a blue light transmission spectrum provided by prior art;

FIG. 1(b) shows an emission spectrum of a quantum dot backlight source and a green light transmission spectrum provided by prior art;

FIG. 2 is a structural schematic diagram of a color film provided in an embodiment of the present disclosure;

FIG. 3 is one structural schematic diagram of a display device provided in an embodiment of the present disclosure;

FIG. 4 is another structural schematic diagram of a display device provided in an embodiment of the present disclosure;

FIG. 5 is a spectrum of a light emitted by a quantum dot backlight source provided in an embodiment of the present disclosure;

FIG. 6(a) is an absorption spectrum of a blue light-absorbing pigment provided in an embodiment of the present disclosure;

FIG. 6(b) is an absorption spectrum of a green light-absorbing pigment provided in an embodiment of the present disclosure;

FIG. 6(c) is an absorption spectrum of a red light-absorbing pigment provided in an embodiment of the present disclosure;

FIG. 7 is still another structural schematic diagram of a display device provided in an embodiment of the present disclosure; and

FIG. 8 is a spectrum of the emergent light from a color film provided in an embodiment of the present disclosure.

### REFERENCE NUMBER LIST

10: emission spectrum of quantum dot backlight source; 20: blue light transmission spectrum; 30: green light transmission spectrum; 40: color film; 401: red color film; 402: green color film; 403: blue color film; 50: first sub-color film; 60: second sub-color film; 70: array substrate; 80: cell aligning substrate; 90: backlight source; and 100: liquid crystal layer.

### DETAILED DESCRIPTION

The technical solutions in embodiments of the present disclosure will be detailedly described below in combination with the drawings. Obviously, the embodiments described are only a part of, not all of the embodiments of the present disclosure. All of other embodiments obtained by those skilled in the art based on the embodiments described, without inventive efforts, fall within the protection scope of the present disclosure.

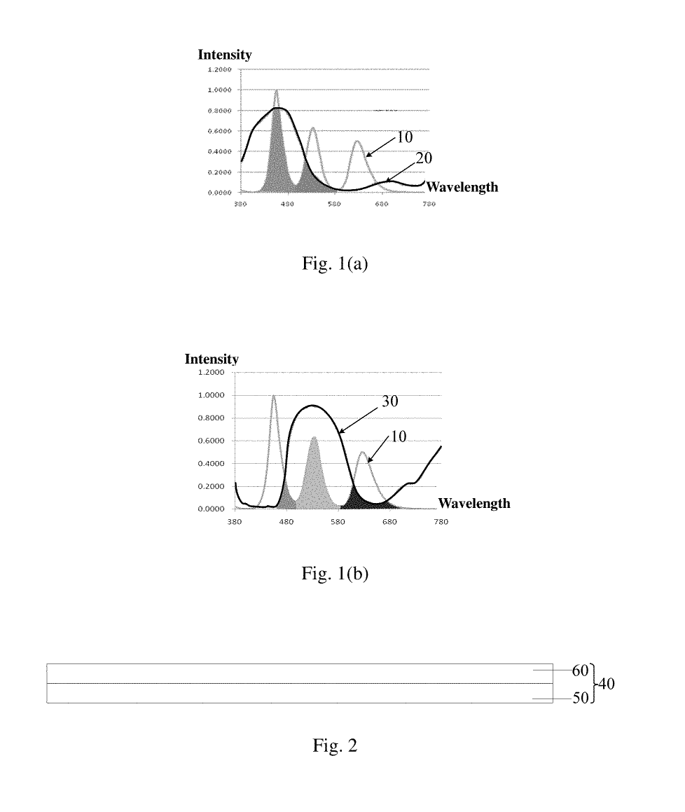

Quantum dot backlight source has been used in the liquid crystal display field. However, when the light emitted by the quantum dot backlight source passes through a conventional color film, a problem that a light with a color different from that of the color film used leaks out may occur. As an example, as shown in FIG. 1(a), 10 is a spectrum of a light emitted by a quantum dot backlight source, and 20 is a blue light transmission spectrum. When the light emitted by the quantum dot backlight source passes through the blue color film, much green light will leak out, influencing the color purity of blue light. And, as shown in FIG. 1(b), 30 is a green light transmission spectrum. When the light emitted by the quantum dot backlight source passes through the green color film, red light and blue light will leak out from the green color film, such that the color purity of green light is reduced, influencing the overall color gamut of the display device.

The present disclosure provides a color film, which can transmit a light with one color of three primary colors, and absorb lights with the other two colors by a first absorbing pigment and a second absorbing pigment respectively; wherein the absorption spectrum ranges of the first absorbing pigment and the second absorbing pigment correspond to the spectral ranges bands of lights with the other two colors of the three primary colors respectively; therefore, after when a light comprising the three primary colors is emitted to the color film, the light with one color can be transmitted while the lights with the other two colors can be absorbed, so that the color purity of the light transmitted through the color film can be increased, improving the color gamut.

In an embodiment according to the first aspect of the present disclosure, provided is a color film for transmitting a light with one color of three primary colors, wherein the color film comprises a first absorbing pigment and a second absorbing pigment, and the absorption spectrum ranges of the first and second absorbing pigments correspond to the spectral bands of lights with the other two colors of the three primary colors respectively.

It should be noted that, first, in order to ensure that the light exited from the color film is the light with one color transmitted alone, and the first absorbing pigment and the second absorbing pigment only absorb the lights with the other two colors having spectral bands corresponding to the absorption spectrum ranges thereof respectively, the lights with three colors emitted to the color film should have emission peaks separated from each other. On this basis, since the emission peaks of the lights with different colors in the spectrum of the light emitted by the quantum dot backlight source are separated from each other, the color film provided in the embodiment of the present disclosure is preferably applied in the device in which the backlight source is a quantum dot backlight source.

Second, the three primary colors can respectively be red, blue and green, or can also be cyan, magenta and yellow, and it is not limited in the present disclosure. For example, the above-described three primary colors may be red, green and blue.

In the case where the three primary colors are respectively red, green and blue, as an example, when the color film is used for transmitting red light, the first absorbing pigment and the second absorbing pigment in the color film are used for absorbing blue light and green light respectively, the absorption spectrum range of the first pigment for absorbing blue light corresponds to the spectral band of blue light, and the absorption spectrum range of the second pigment for absorbing green light corresponds to the spectral band of green light; when the color film is used for transmitting green light, the first absorbing pigment and the second absorbing pigment in the color film are used for absorbing blue light and red light respectively, the absorption spectrum range of the first pigment for absorbing blue light corresponds to the spectral band of blue light, and the absorption spectrum range of the second pigment for absorbing red light corresponds to the spectral band of red light; when the color film is used for transmitting blue light, the first absorbing pigment and the second absorbing pigment in the color film are used for absorbing green light and red light respectively, the absorption spectrum range of the first pigment for absorbing green light corresponds to the spectral band of green light, and the absorption spectrum range of the second pigment for absorbing red light corresponds to the spectral band of red light.

Third, the first absorbing pigment and the second absorbing pigment are not limited, and they can be organic pigments or inorganic pigments, as long as they can absorb the lights with the other two colors than that of the transmitted light in the three primary colors.

Preferably, the above-described pigments are organic pigments, because organic pigments are inexpensive and easy to produce, the position of maximum absorption wavelength and half peak width in the absorption spectrum can be changed easily by modifying the functional groups in the molecular structure of the organic pigment, and they have good compatibility with the resin in the color film and are also soluble in the solvent of the color film.

On this basis, with respect to the content of the first absorbing pigment and the second absorbing pigment in the color film, it should be ensured that the lights with the other two colors than that of the transmitted light can be completely absorbed while the normal transmission of the transmitted light will not be influenced.

Fourth, in addition to the first absorbing pigment and the second absorbing pigment, the color film may further comprise components such as a resin, an unsaturated double bond-containing monomer, a photo-initiator, a silicone coupling agent, an auxiliary agent, a solvent and the like. These components can be the same as the corresponding components in a conventional color film.

Fifth, the color film can be configured to be one-layered, which comprises a first absorbing pigment and a second absorbing pigment; and certainly, the color film can also be configured to be two-layered, one of which comprises a first absorbing pigment and the other of which comprises a second absorbing pigment.

In one embodiment, as shown in FIG. 2, a color film 40 comprises a first sub-color film 50 and a second sub-color film 60 disposed as a stack; and the first sub-color film 50 comprises a first absorbing pigment, and the second sub-color film 60 comprises a second absorbing pigment.

Here, the positions of the first sub-color film 50 and the second sub-color film 60 are not limited. It is possible that the first sub-color film 50 is disposed above and the second sub-color film 60 is disposed below; and it is also possible that the first sub-color film 50 is disposed below and the second sub-color film 60 is disposed above.

In the embodiment, the color film 40 comprises a first sub-color film 50 and a second sub-color film 60 disposed as a stack; and the first sub-color film 50 comprises a first absorbing pigment, and the second sub-color film 60 comprises a second absorbing pigment. When lights enter the first sub-color film 50, the first sub-color film 50 can absorb the light with one color of the three primary colors since it comprises the first absorbing pigment, and when the lights enter the second sub-color film 60, the second sub-color film 60 can absorb the light with another color of the three primary colors since it comprises the second absorbing pigment, as a result, only a light with one color can be transmitted when the light exits from the color film 40. Because the color film 40 comprises two layers, lights with the other two colors than that of the light transmitted through the color film 40 can be absorbed sufficiently, such that the color purity of the light transmitted through the color film 40 can be further increased.

In some embodiments, the absorption spectrum range of the first absorbing pigment can correspond to the spectral band of red light, and the first absorbing pigment has a molecular structural formula of:

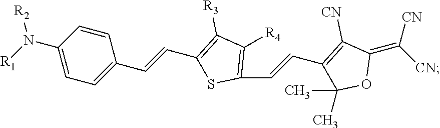

wherein, R₁ and R₂ each are independently selected from one of —H, —(CH₂)ₙ—CH₃ (n=0-10), —CH₂(CH₂)ₙOH (n=0-10),

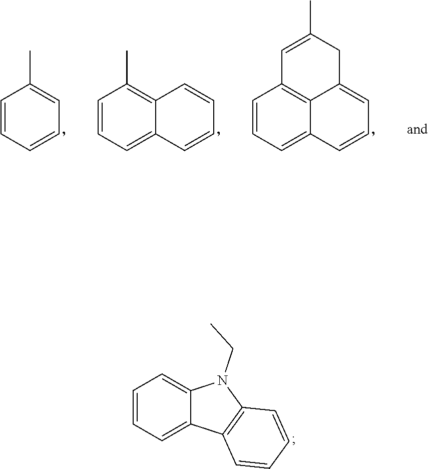

and R₃ and R₄ each are independently selected from one of —H, —(CH₂)ₙ—CH₃ (n=0-11), —O—(CH₂)ₙ—CH₃ (n=0-11), —O—Si(CH₃)₂— Si(CH₃)₃, —O—Si(CH₃)₃, and

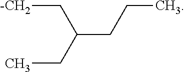

When the molecular structural formula of the first absorbing pigment is the above-described molecular structural formula, the first absorbing pigment can absorb red light. On this basis, the position of maximum absorption wavelength and half peak width in the absorption spectrum of the red light-absorbing first absorbing pigment can be adjusted by modifying R₁ and/or R₂ or R₃ and/or R₄ in the molecular structural formula of the first absorbing pigment.

In some embodiments, the absorption spectrum range of the first absorbing pigment can correspond to the spectral band of blue light, and the first absorbing pigment has a molecular structural formula of:

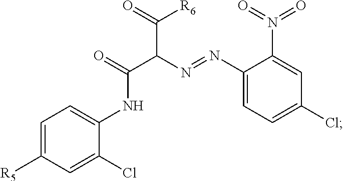

wherein, R₅ and R₆ each are independently selected from one of —H, —(CH₂)ₙ—CH₃ (n=0-10), —CH₂(CH₂)ₙOH (n=0-10),

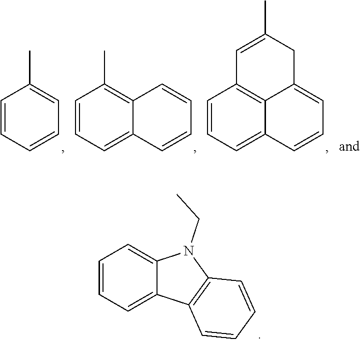

When the molecular structural formula of the first absorbing pigment is the above-described molecular structural formula, the first absorbing pigment can absorb blue light. On this basis, the position of maximum absorption wavelength and half peak width in the absorption spectrum of the blue light-absorbing first absorbing pigment can be adjusted by modifying R₅ and/or R₆ in the molecular structural formula of the first absorbing pigment.

In some embodiments, the absorption spectrum range of the first absorbing pigment can correspond to the spectral band of green light, and the first absorbing pigment has a molecular structural formula of:

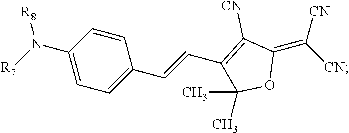

wherein, R₇ and R₈ each are independently selected from one of —H, —(CH₂)ₙ—CH₃ (n=0-10), —CH₂(CH₂)ₙOH (n=0-10),

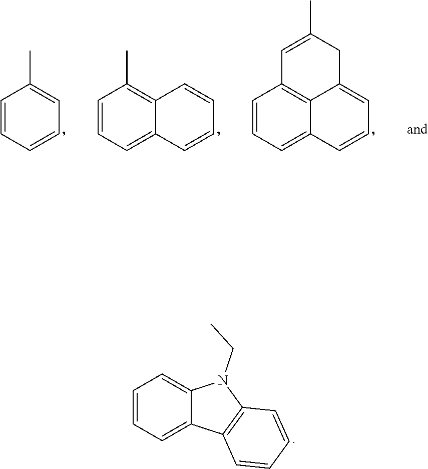

When the molecular structural formula of the first absorbing pigment is the above-described molecular structural formula, the first absorbing pigment can absorb green light. On this basis, the position of maximum absorption wavelength and half peak width in the absorption spectrum of the green light-absorbing first absorbing pigment can be adjusted by modifying R₇ and/or R₈ in the molecular structural formula of the first absorbing pigment.

It is noted that, those skilled in the art shall appreciate that the absorption of red light, green light or blue light is mainly related to the number of conjugated double bonds, the electro-donating group and the electron-withdrawing group in the molecular structural formula of the first absorbing pigment. Thus, in the present disclosure, the molecular structural formulae of the first absorbing pigments which absorb red light, green light and blue light are not limited to the above-described molecular structural formulae of the first absorbing pigment, and can also be another first absorbing pigment which comprises a certain number of conjugated double bonds, an electro-donating group and an electron-withdrawing group. In addition, the molecular structural formulae of the second absorbing pigments which absorb red light, green light and blue light can be the same as those of the first absorbing pigments, and of course, the molecular structural formulae of the second absorbing pigments which absorb red light, green light and blue light can also be different from those of the first absorbing pigments, as long as the second absorbing pigment can absorb red light or blue light or green light. On this basis, the peak heights of the first absorbing pigment and the second absorbing pigment can also be adjusted by changing the mass percent contents of the first absorbing pigment and the second absorbing pigment.

In addition, the first absorbing pigment and the second absorbing pigment can also be inorganic pigments. When the first absorbing pigment and the second absorbing pigment are inorganic pigments, corresponding inorganic pigments can be added depending on the spectral band of the light to be absorbed, and the position of the maximum absorption wavelength and the half peak width in the absorption spectrum of the inorganic pigment can be adjusted by adjusting the elements in the inorganic pigment and the particle size of the inorganic pigment.

In some embodiments, when the color film 40 is one layer, the sum of the mass percent contents of the first absorbing pigment and the second absorbing pigment is 5%˜40%; and when the color film 40 comprises the first sub-color film 50 and the second sub-color film 60 disposed as a stack, the mass percent content of the first absorbing pigment in the first sub-color film 50 is 5%˜40%, and the mass percent content of the second absorbing pigment in the second sub-color film 60 is 5%˜40%.

Here, when the color film 40 is one layer, the mass percent content of each of the first absorbing pigment and the second absorbing pigment is not limited, as long as the sum of the mass percent contents of the first absorbing pigment and the second absorbing pigment is 5%˜40%. The mass percent contents of the first absorbing pigment and the second absorbing pigment can be the same or different. Particularly, the mass percent contents of the first absorbing pigment and the second absorbing pigment can be accordingly adjusted depending on the amounts of the lights with two colors to be absorbed in the lights with three primary colors.

On this basis, the mass percent contents of other components in the color film 40 are as follows: resin: 5%˜45%, unsaturated double bond-containing monomer: 0.5%˜18%, photo-initiator: 0.1%˜3%, silicone coupling agent: 0.1%˜7%, auxiliary agent: 0.1%˜1%, and solvent: 40%˜85%.

In the embodiments of the present disclosure, the first absorbing pigment, the second absorbing pigment and the above-described components in the color film 40 collectively enable that the color film 40 transmits one color of the three primary colors while absorbing the other two colors, so as to increase the color purity of the light emitted from the color film 40, improving the color gamut.

In the embodiments of the present disclosure, when the mass percent contents of the first absorbing pigment and the second absorbing pigment in the color film 40 are too low, it is possible that the lights with two colors required to be absorbed in the three primary colors are not completely absorbed; and when the mass percent contents of the first absorbing pigment and the second absorbing pigment in the color film 40 are too high, the contents of other components in the color film 40 will be reduced, which may cause that the light to be transmitted cannot be normally transmitted.

In embodiments according to the second aspect of the present disclosure, provided is a substrate comprising the color film 40 described above.

Here, the substrate is not limited, and for example, it can be an array substrate or a cell aligning substrate.

When used in a liquid crystal display, the color film 40 can be positioned on a side of the array substrate or cell aligning substrate faced to the liquid crystal layer.

Because the color film 40 on the substrate can transmit a light with one color of three primary colors, and lights with the other two colors can be absorbed by the first absorbing pigment and the second absorbing pigment respectively, with the absorption spectrum ranges of the first and second absorbing pigments corresponding to the spectral bands of lights with the other two colors of the three primary colors respectively; therefore, after a light comprising the three primary colors is emitted to the color film, only the light with one color can be transmitted while the lights with the other two colors can be absorbed, so that the color purity of the light transmitted through the color film 40 can be increased, improving the color gamut.

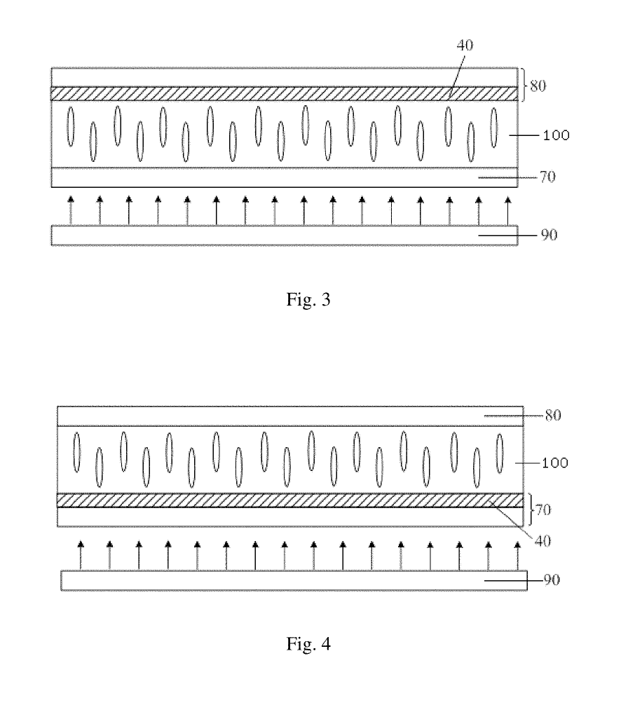

In embodiments according to the third aspect of the present disclosure, provided are display devices, as shown in FIG. 3 and FIG. 4, which comprise an array substrate 70, a cell aligning substrate 80, a backlight source 90, and a liquid crystal layer 100 positioned between the array substrate 70 and the cell aligning substrate 80; wherein, the array substrate 70 or the cell aligning substrate 80 comprises the color film 40 described above.

Here, the color film 40 can be disposed on the cell aligning substrate 80 as shown in FIG. 3, or can be disposed on the array substrate 70 as shown in FIG. 4. Preferably, the color film 40 is positioned on a side of the array substrate 70 or the cell aligning substrate 80 faced to the liquid crystal layer 100.

Since the emission peak of blue light, the emission peak of green light and the emission peak of red light are separated from each other in the spectrum 10 of the light emitted by quantum dots, as shown in FIG. 1(a) and FIG. 1(b), the lights with two colors in the three primary colors can be absorbed by using the first absorbing pigment and the second absorbing pigment without influencing the remaining light. As such, the backlight source 90 is preferably a quantum dot white backlight source.

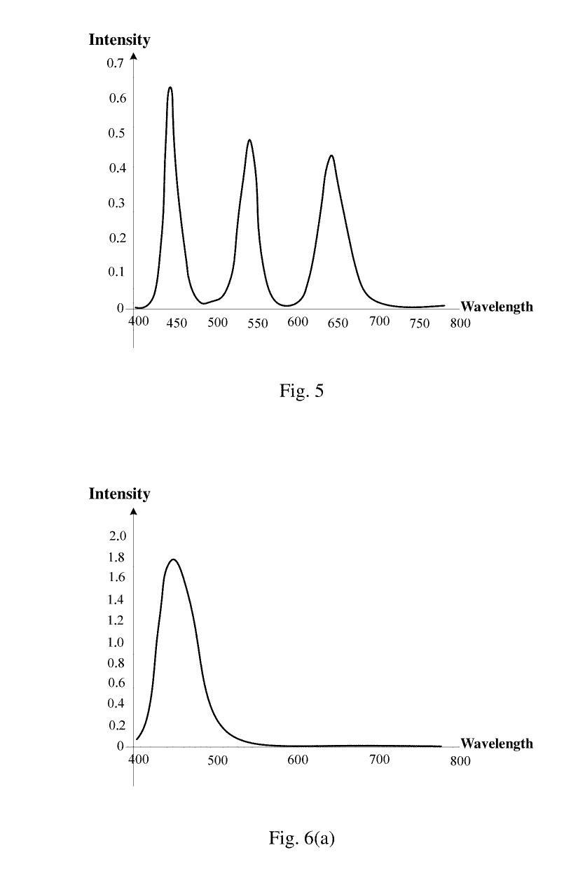

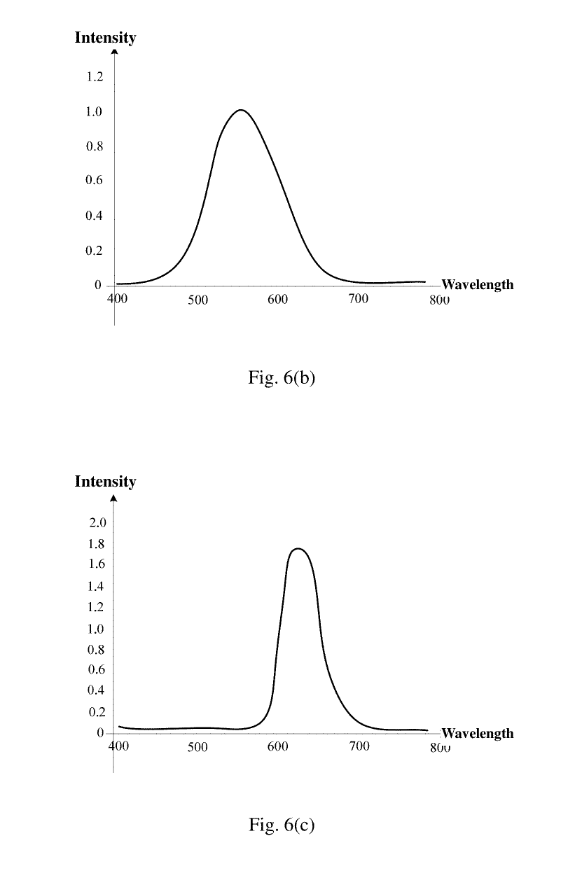

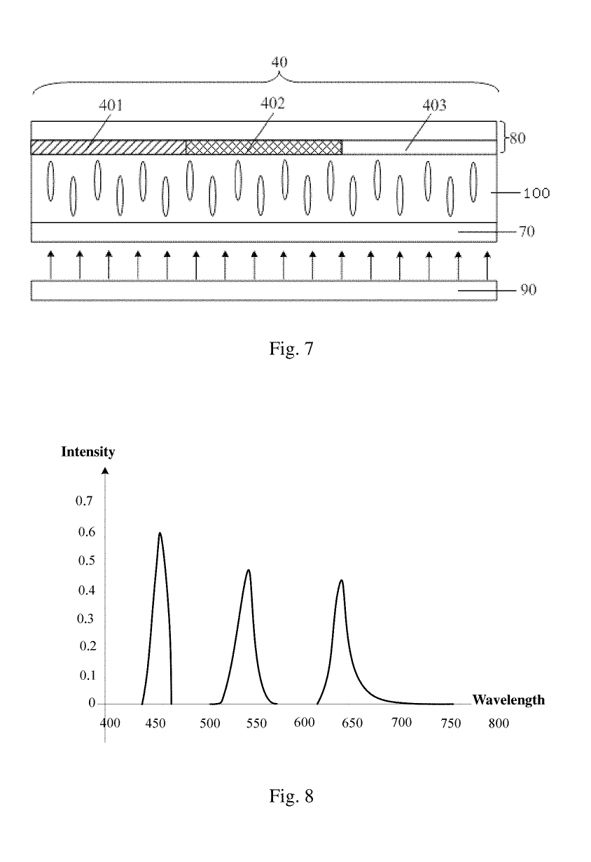

As an example, the spectrum of the light emitted by the quantum dot backlight source is as shown in FIG. 5, the blue light absorption spectrum of the first absorbing pigment and the second absorbing pigment is as shown in FIG. 6(a), the green light absorption spectrum of the first absorbing pigment and the second absorbing pigment is as shown in FIG. 6(b), and the red light absorption spectrum of the first absorbing pigment and the second absorbing pigment is as shown in FIG. 6(c). When the display device comprises three kinds of color films as shown in FIG. 7, the three kinds of color films are respectively red color film 401, green color film 402 and blue color film 403, wherein the red color film 401 can transmit red light, and the first absorbing pigment and the second absorbing pigment in the red color film absorb blue light and green light respectively; the blue color film 403 can transmit blue light, and the first absorbing pigment and the second absorbing pigment in the blue color film absorb red light and green light respectively; and the green color film 402 can transmit green light, and the first absorbing pigment and the second absorbing pigment in the green color film absorb red light and blue light respectively. Here, any one of the red color film 401, the green color film 402 and the blue color film 403 can comprise a first sub-color film and a second sub-color film disposed as a stack, and the first and second absorbing pigments can be contained in the first and second sub-color films respectively.

On this basis, when the light emitted by the quantum dot backlight source passes through the blue color film 403, the first absorbing pigment and the second absorbing pigment in the blue color film 403 absorb red light and green light respectively, and as seen from the left emission peak in FIG. 8, the half peak width of the emission peak of the blue light exited from the blue color film 403 is narrower and the color purity is higher; when the light emitted by the quantum dot backlight source passes through the green color film 402, the first absorbing pigment and the second absorbing pigment in the green color film 402 absorb red light and blue light respectively, and as seen from the middle emission peak in FIG. 8, the half peak width of the emission peak of the green light exited from the green color film 402 is narrower and the color purity is higher; and when the light emitted by the quantum dot backlight source passes through the red color film 401, the first absorbing pigment and the second absorbing pigment in the red color film 401 absorb green light and blue light respectively, and as seen from the right emission peak in FIG. 8, the half peak width of the emission peak of the red light exited from the red color film 401 is narrower.

The above descriptions are only some particular embodiments of the present disclosure, but the protection scope of the present application is not limited thereto. Within the technical scope disclosed in the present application, one skilled in the art can readily envisage variations and alternatives, and all of them are covered by the protection scope of the present application. Therefore, the protection scope of the present application is defined by the appended claims.

1. A color film for transmitting a light with a first color of three primary colors, wherein the color film comprises a first absorbing pigment and a second absorbing pigment, and absorption spectrum ranges of the first absorbing pigment and the second absorbing pigment correspond to spectral bands of lights with second and third colors of the three primary colors respectively.

2. The color film according to claim 1, wherein the three primary colors are red, green and blue.

3. The color film according to claim 1, wherein the light comprising the three primary colors is emitted by a quantum dot white light source.

4. The color film according to claim 1, wherein the first absorbing pigment and/or the second absorbing pigment are/is an organic pigment.

5. The color film according to claim 1, wherein the absorption spectrum range of the first absorbing pigment corresponds to the spectral band of red light, and the first absorbing pigment has a molecular structural formula of: 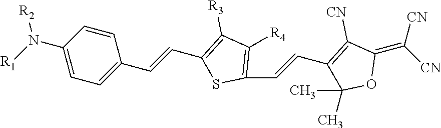
wherein, R₁ and R₂ each are independently selected from one of —H, —(CH₂)ₙ—CH₃ (n=0-10), —CH₂(CH₂)ₙOH (n=0-10), 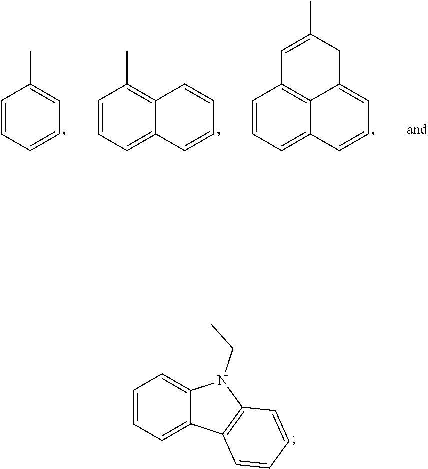
and R₃ and R₄ each are independently selected from one of —H, —(CH₂)ₙ—CH₃ (n=0-11), —O—(CH₂)ₙ—CH₃ (n=0-11), —O—Si(CH₃)₂—Si(CH₃)₃, —O—Si(CH₃)₃, and

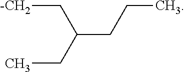

6. The color film according to claim 1, wherein the absorption spectrum range of the first absorbing pigment corresponds to the spectral band of blue light, and the first absorbing pigment has a molecular structural formula of: 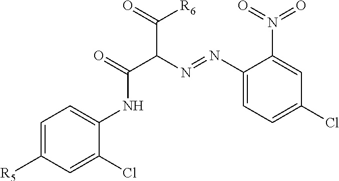
wherein, R₅ and R₆ each are independently selected from one of —H, —(CH₂)ₙ—CH₃ (n=0-10), —CH₂(CH₂)ₙOH (n=0-10),

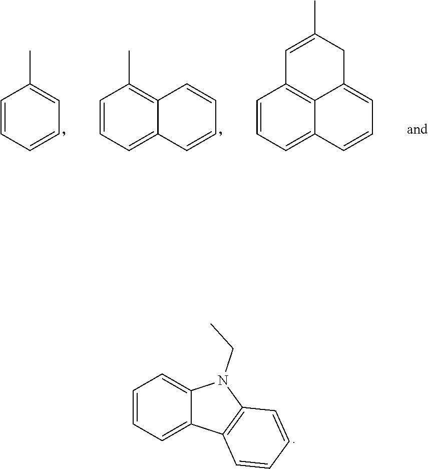

7. The color film according to claim 1, wherein the absorption spectrum range of the first absorbing pigment corresponds to the spectral band of green light, and the first absorbing pigment has a molecular structural formula of: 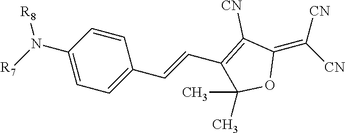
wherein, R₇ and R₈ each are independently selected from one of —H, —(CH₂)ₙ—CH₃ (n=0-10), —CH₂(CH₂)ₙOH (n=0-10),

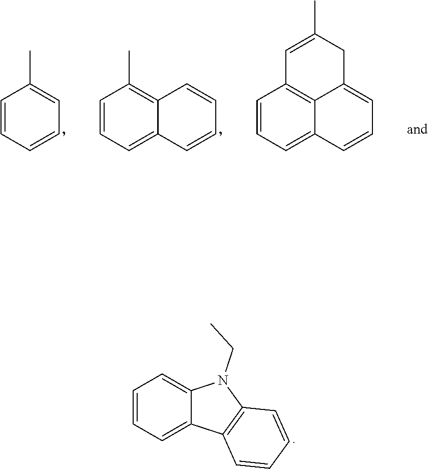

8. The color film according to claim 1, wherein the sum of the mass percent contents of the first absorbing pigment and the second absorbing pigment in the color film is 5%˜40%.

9. The color film according to claim 1, wherein the color film further comprises a resin, an unsaturated double bond-containing monomer, a photo-initiator, a silicone coupling agent, an auxiliary agent and a solvent.

10. The color film according to claim 1, wherein the color film comprises a first sub-color film and a second sub-color film disposed as a stack;
wherein the first sub-color film comprises the first absorbing pigment, and the second sub-color film comprises the second absorbing pigment.

11. The color film according to claim 10, wherein
the mass percent content of the first absorbing pigment in the first sub-color film is 5%˜40%, and the mass percent content of the second absorbing pigment in the second sub-color film is 5%˜40%.

12. A substrate comprising the color film of claim 1.

13. A display device comprising a backlight source, an array substrate, a cell aligning substrate, and a liquid crystal layer positioned between the array substrate and the cell aligning substrate;
wherein the array substrate or the cell aligning substrate comprises the color film of claim 1.

14. The display device according to claim 13, wherein the backlight source is a quantum dot white backlight source.

15. The display device according to claim 13, wherein the color film includes three kinds of color films each of which transmits a light with one color of the three primary colors.

16. The display device according to claim 15, wherein the color film includes a red color film, a green color film and a blue color film.
